(19) United States
(12) Patent Application Publication
(10) Pub. No.: US 2010/0231077 A1
(43) Pub. Date: Sep. 16, 2010

(54) DUAL MACHINE, AND METHOD OF POWER GENERATION AND ELECTROMOTIVE OPERATION USING THE SAME

(76) Inventor: Jae Shin Yun, Glendale Heights, IL (US)

Correspondence Address: IPLA P.A., 3550 WILSHIRE BLVD., 17TH FLOOR, LOS ANGELES, CA, 90010, US

(21) Appl. No.: 12/774,656

(22) Filed: May 5, 2010

Related U.S. Application Data
(63) Continuation of application No. 11/306,097, filed on Dec. 15, 2005, now abandoned.

(30) Foreign Application Priority Data
Sep. 16, 2008 (KR) 10-2005-0086642

(51) Int. Cl. H02K 47/04; H02K 53/00

(52) U.S. Cl. 310/113; 415/916

(57) ABSTRACT

Provided is dual machine and method of power generation and electromotive operation. The dual machine includes a left and a right assembly. The left and right assemblies have first and second magnets, use magnetic current and force, and operate alternately varying polarity under control of a control device. When the assemblies simultaneously operate while performing a stroke, magnetic vector by the first magnets is converted into rotational torque at the second magnets by interaction and harmony between vector and current motion by the magnet parts of the left and right assemblies, and allows the dual machine to function as a motor. Magnetic current motion by the first magnets allows the dual machine to function as a generator due to harmony between attractive and repulsive current at the second magnets. Electromotive force and torque force are output based on the dual function of the motor and the generator.

### CROSS REFERENCES

This application is a continuation of U.S. patent application Ser. No. 11/306,097 filed Dec. 15, 2005, which claims foreign priority under Paris Convention to Korean Patent Application No. 10-2005-0086642, filed Sep. 16, 2008, where the entire contents are incorporated herein by reference.

### BACKGROUND OF THE INVENTION

The present invention relates generally to a dual machine, in which a generator and a motor are integrated into a single body, and which replaces an existing generator and an existing motor that have been separately used, and a method of power generation and operation using the same and, more particularly, to a dual machine, in which, when attraction acts between the stator and rotor poles of a right assembly based on the natural motion of a base magnet, the stator and rotor poles of a left assembly repeatedly perform repulsive action, alternation operation is repeated, and the attractive action is transformed into an attractive vector and attractive current and, at the same time, the repulsive action is transformed into an repulsive vector and repulsive current, so that the attractive current and the repulsive current become relatively large output compared to force input as activation electricity, and a method of power generation and operation using the same.

It is well known that a generator and a motor, which are currently used, have been separately and individually developed. That is, the generator has been described and developed using a direct method, that is, a direct magnetic vector motion method, and a method of generating power using the generator requires the supply of a large amount of energy. Furthermore, the motor generates heat due to magnetic current at the time of electromotive operation. Furthermore, in the motor, phenomena that interfere with electromotive operation occur due to hysteresis, eddy current, and energy consumption, and a cooling device for eliminating heat generated upon electromotive operation must be provided, so that a large amount energy is consumed.

Furthermore, in current research and development, the invisible magnetic current of the generator and the motor is not taken into account, so that stroke processing of magnetic current cannot be conducted, devices for forming both attractive action and repulsive action cannot be arranged, and energy for the attractive action and the repulsive action, which occur independently, cannot be efficiently used. As a result, a large amount of energy is consumed.

Prior arts by Minato et al (U.S. Pub 2005/0184613) and Yun (U.S. Pat. No. 6,504,285) tried to address a couple of improvements in a magnetic rotating motor generator and a vector motor, respectively, but still left problems to solve.

### SUMMARY OF THE INVENTION

Accordingly, the present invention has been made keeping in mind the above problems occurring in the prior art, and an object of the present invention is to provide a dual machine, which performs both motor and generator functions using a pair of assemblies which operate while allowing attractive current and repulsive current, and attractive vectors and repulsive vectors, which are generated from a pair of magnets, to be harmonized with each other using an electronic controller, thus acquiring energy at high efficiency, and a method of power generation and electromotive operation using the same.

In order to accomplish the above object, the present invention provides a dual machine, including: a left assembly having a plurality of first magnets; and a right assembly having a plurality of second magnets facing the first magnets; wherein the left and right assemblies use both magnetic current and magnetic force, and operate while alternately varying polarity under the control of an electronic control device, when the left and right assemblies simultaneously operate while performing a single completed stroke motion, magnetic vector motion generated by the plurality of first magnets is converted into rotational torque at the plurality of second magnets by interaction and harmony between magnetic vector motion and magnetic current motion generated by the magnet parts of the left and right assemblies, and allows the dual machine to function as a motor, magnetic current motion generated by the plurality of first magnets allows the dual machine to function as a generator due to harmony between attractive current and repulsive current at the plurality of second magnets, and electromotive force and torque force are output based on the dual function of the motor and the generator.

In addition, the present invention provides a method of power generation and electromotive operation using a dual machine based on magnetic current and magnetic force, the dual machine including a first rotor and a first stator, which are arranged to correspond to each other in the form of a first rotor-stator pair, and a second rotor and a second stator, configured to have a construction identical to that of the first rotor-stator pair and connected by a rotational axis, the method including the steps of: the rotational axis rotating when power is supplied from the outside; the first rotor rotating in response to the rotation of the rotational axis, the first rotor inserted into the rotational axis and composed of a plurality of rotational arms, each having an action member and reaction member; magnetic vectors acting between magnetic current, which is generated by the rotor magnets of ends of the first rotor, and magnetic current, which is generated by stator electromagnets; acquiring electromagnetic force, which is generated by action between the first stator electronic magnets and the rotor magnets, by adjusting either an amount or phase of magnetic current induced by the wound coils of the first stator using a controller, and outputting the electromagnetic force from a conduction wire based on a torque characteristic in which a size of the first rotor is determined according to the amount or phase of the magnetic current induced by the wound coils; allowing the magnetic vectors to be strengthened by variation in repulsive current and attractive current between the stator electronic magnets and the rotor magnets, depending on the rotation of the action members and reaction members of the rotational arms of the first rotor; and outputting strong electromotive force from the coils wound to the stator electromagnet using the strengthened magnetic current.

An existing generator and an existing motor are disadvantageous from the point of view of energy and technology because the existing generator consumes energy due to binding friction attributable to magnetic force generated from electromagnets in the case of power generation and the existing motor consumes energy due to conversion into heat energy by magnetic current. However, a dual machine using dual principle of the present invention uses the intrinsic natural motion of a magnet, uses the two polarities at respective ends of an electromagnet, and combines magnetic current motion and magnetic vector motion while allowing the interaction and harmonized motion of the magnet and the electromagnet to occur simultaneously, so that decrease in performance caused by the consumption of heat energy and the like, is eliminated and, therefore, energy efficiency can increase. Furthermore, the dual machine according to the present invention provides multiple functions, so that it conserves energy, thereby solving problems, such as environmental pollution and the exhaustion of fossil fuel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing the structure of the left and right assemblies of a dual machine according to the present invention;

FIG. 2 is an exploded perspective view of the structure shown in FIG. 1;

FIG. 3 is a front view of the structure shown in FIG. 1;

FIG. 4 is a block diagram showing the construction of an electronic control device for controlling the dual machine according to the present invention; and

FIG. 5 is a chart showing an example of the operation states of the dual machine according to the present invention.

### DESCRIPTION OF SPECIFIC EMBODIMENTS

A dual machine and a method of power generation and electromotive operation using a dual machine according to the present invention are described below.

The dual machine 200 includes a left assembly 100 having a plurality of first magnets and a right assembly 100′ having a plurality of second magnets facing the first magnets. The left and right assemblies 100 and 100′ use both magnetic current and magnetic force, and operate while alternately varying polarity under the control of an electronic control device. When the left and right assemblies 100 and 100′ simultaneously operate while performing a single completed stroke motion, magnetic vector motion generated by the plurality of first magnets is converted into rotational torque at the plurality of second magnets by interaction and harmony between magnetic vector motion and magnetic current motion generated by the magnet parts of the left and right assemblies, and allows the dual machine to function as a motor, magnetic current motion generated by the plurality of first magnets allows the dual machine to function as a generator due to harmony between attractive current and repulsive current at the plurality of second magnets, and electromotive force and torque force are output based on the dual function of the motor and the generator.

Furthermore, in the dual machine 200 according to the present invention, the right assembly 100′ includes stator poles 20′ and rotor poles 10′, the stator poles 20′ and the rotor poles 10′ performs attractive motion and repulsive motion in harmony with each other, so that, when left wound coils are driven, electricity is output from right wound coils. Furthermore, the stator poles 20′ and the rotor poles 10′ simultaneously performs input and output under the electronic control device, thus alternately interacting.

In addition, the present invention provides the method of power generation and electromotive operation using the dual machine 200 based on magnetic current and magnetic force, the dual machine 200 including a first rotor and a first stator, which are arranged to correspond to each other in the form of a first rotor-stator pair, and a second rotor and a second stator, configured to have a construction identical to that of the first rotor-stator pair and connected by a rotational axis 2, the method comprising the steps of: the rotational axis 2 rotating when power is supplied from the outside; the first rotor rotating in response to the rotation of the rotational axis 2, the first rotor inserted into the rotational axis and composed of a plurality of rotational arms, each having an action member 3 and reaction member 4; magnetic vectors acting between magnetic current, which is generated by the rotor magnets of ends of the first rotor, and magnetic current, which is generated by stator electromagnets; acquiring electromagnetic force, which is generated by action between the first stator electronic magnets and the rotor magnets, by adjusting either an amount or a phase of magnetic current induced by the wound coils of the first stator using a controller, and outputting the electromagnetic force from a conduction wire based on a torque characteristic in which a size of the first rotor is determined according to the amount or phase of the magnetic current induced by the wound coils; allowing the magnetic vectors to be strengthened by variation in repulsive current and attractive current between the stator electronic magnets and the rotor magnets, depending on the rotation of the action members 3 and reaction members 4 of the rotational arms of the first rotor; and outputting strong electromotive force from the coils wound to the stator electromagnet using the strengthened magnetic current.

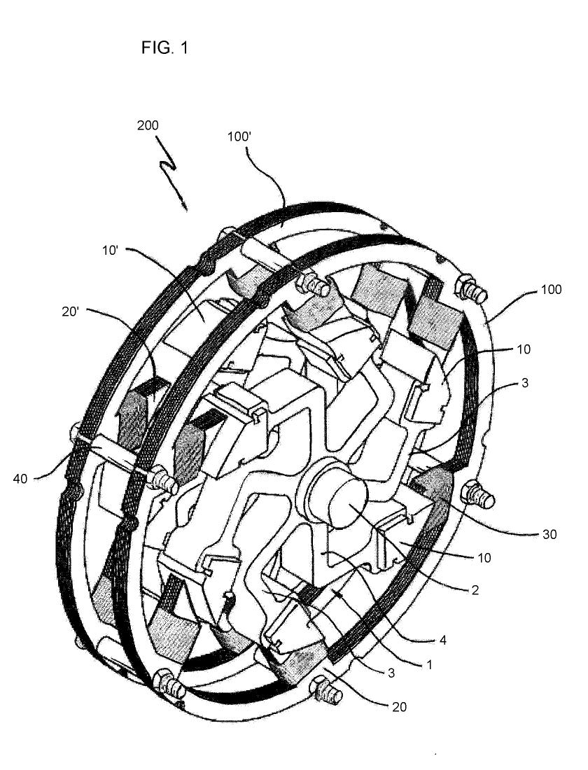

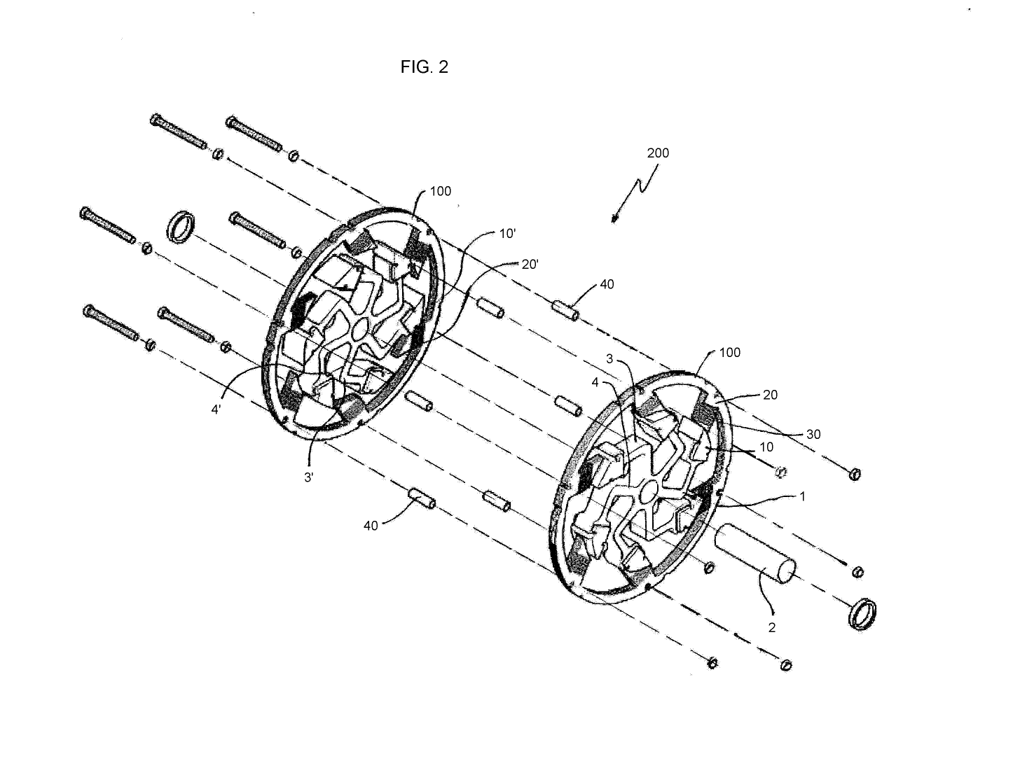

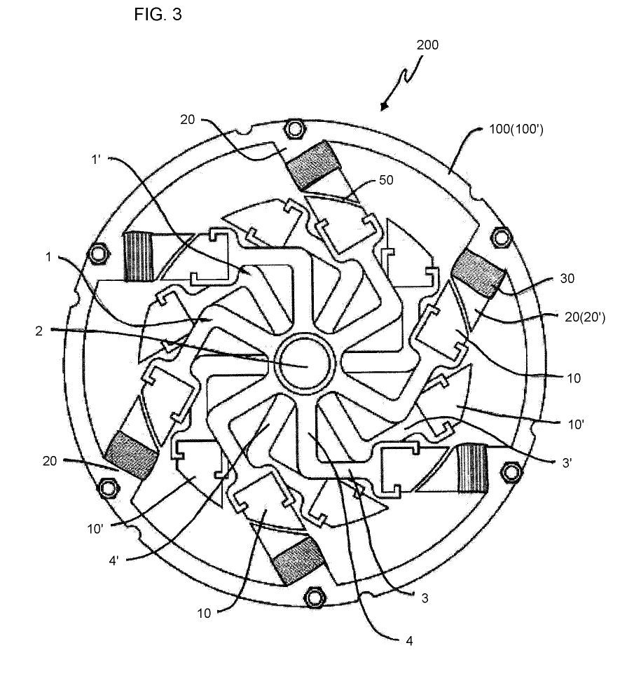

A preferred embodiment of the present invention will be more clearly understood when descriptions thereof are made below with reference to the accompanying drawings, that is, FIGS. 1 to 5. FIGS. 1, 2 and 3 are views showing the structure of a dual machine according to the present invention, the left and right assemblies of which operate in harmony with each other. For descriptions made in conjunction with the drawings, the same reference numerals are used throughout the different drawings to designate the same or similar components.

In the present invention, the term “dual machine” refers to an apparatus in which a generator and a motor that operate simultaneously based on a dual principle are integrated into a single body, and the term “wound coil” refers to a wound coil member wound into a coil.

The dual machine 200 is a single basic assembly, and includes a right assembly 100′ and a left assembly 100. The right assembly 100′ and the left assembly 100 are coupled with each other by a rotational axis 2 and spacers 40 to form a pair. Each of the right and left assemblies 100′ includes a stator and a rotor. When attractive motion occurs at the right assembly 100′, repulsive motion occurs at the left assembly 100. In order to cause the motions to be alternately performed, the dual machine 200 includes an electronic control device.

The right assembly 100′ includes stator poles 20′ and rotor poles 10′, and the left assembly 100 includes stator poles 20 and rotor poles 10. The two types of stator poles 20 and 20′ are arranged across electromagnets, that is, wound coils, and the two types of rotor poles 10 and 110′ are composed of permanent magnets and are radially arranged. The attractive motion and the repulsive motion alternately act under the control of the electronic control device.

When the right and left assemblies 100′ and 100 interact, the stator electromagnets and rotor permanent magnets of the right assembly 100′ conduct the attractive motion and, at the same time, the stator electromagnets and rotor permanent magnets of the left assembly 100 conduct the repulsive motion. Consequently, a pair of attractive and repulsive magnetic currents and a pair of attractive and repulsive magnetic vectors are generated, and are harmonized with each other upon rotation in a counterclockwise direction.

With reference to the right assembly 100′, the right assembly 100′ includes the stator poles 20′ and the rotor poles 110′. When the stator poles 20′ and the rotor poles 10′ respectively perform the attractive motion and the repulsive motion in harmony with each other, the attractive motion assumes an invisible leading part as magnetic current motion that is not visible by humans, and the repulsive motion assumes a visible leading part as magnetic current motion that is visible by humans. For this reason, right wound coils output electricity when the left wound coils are driven. In this case, input and output operations are also simultaneously performed under the control of the electronic control device, so that the interaction is alternately conducted.

Therefore, the right stator poles 20′ and the left stator 20 are connected to magnetic conductors, and the right rotor 10′ and the left rotor 10 are also connected to magnetic conductors, so that the magnetic current motion, which is the core technology of the present invention, is smoothly performed, and the magnetic vector motion maintains action and reaction at vectorial angles. As a result, a sum vector is formed, and the generator and the motor, based on the dual principles that are the core technology of the present invention, become a dual machine.

In the case where a magnetic current system, including magnetic motion that is generated by the generator, and a magnetic vector motion system, including magnetic vector motion that is generated by the motor, form a unit stroke, the dual machine according to the present invention forms a magnetic system, including on/off operation for supplying power at the time of initial operation, the input and output of the power of the wound coils, N and S poles for generating electromagnetic force, the attractive current and the attractive vector that interact between the N and S poles, N and N poles for generating electromagnetic force, and the repulsive current and the repulsive vector that interact between the N and N poles.

In this case, the magnetic motion is conducted in such a manner that the half stroke of a first position, which is the previous stroke of the right and left assemblies, and the half stroke of a second position, which is the post stroke of the right and left assemblies, completes a single stroke.

In the dual machine according to the present invention, the left assembly and the right assembly 100′ simultaneously operate with the spacers 40 disposed between the left assembly and the right assembly 100′, which is described below.

In magnetic motion, which is the fundamental principle of the power-generating and electromotive operation of the dual machine according to the present invention, magnetic current motion and magnetic vector motion, which generate magnetic current and magnetic force, are achieved by constructing the right assembly, constituting a set of magnetic current systems, and the left assembly, constituting another set of magnetic current and magnetic force systems, and simultaneously operating the left and right assemblies.

Furthermore, in a power generating and electromotive operation method using the dual machine according to the present invention, the stator and the rotor conduct a single stroke of rotational motion in such a manner that a first rotor-stator pair, which is formed of an N and S pole pair, employing attractive current and repulsive current, and a second rotor-rotor pair, which is formed of an N and N pole pair, employing a repulsive vector and a repulsive vector, operate alternately.

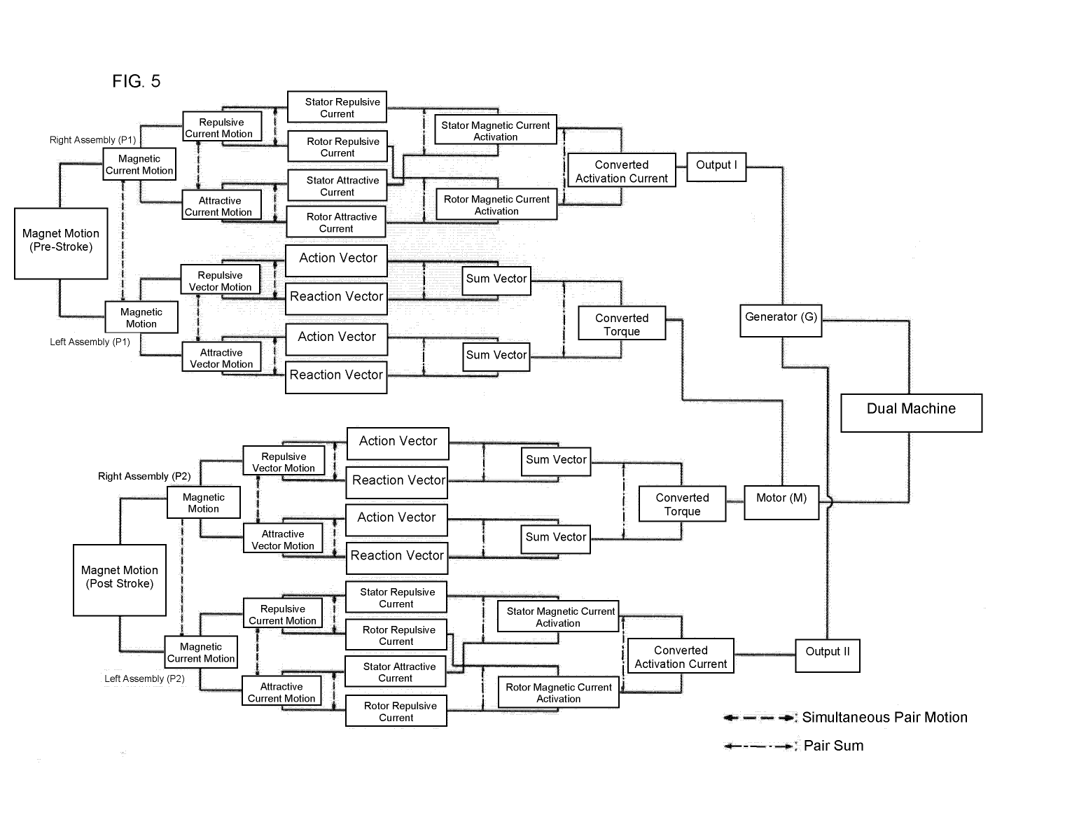

FIG. 5 is a chart showing an example of the operation states of the dual machine according to the present invention. The right assembly 100′ in a first position P1 in FIGS. 1 to 3, and the left assembly 100 in a second position P2 in FIGS. 1 to 3 are coupled with each other and perform a pair of pre-stroke motions, and the right assembly 100′ of the first position P1 and the left assembly 100 of the second position P2 perform a pair of post-stroke motions. As a result, the first and second strokes are added to each other and, thus become a single stroke motion.

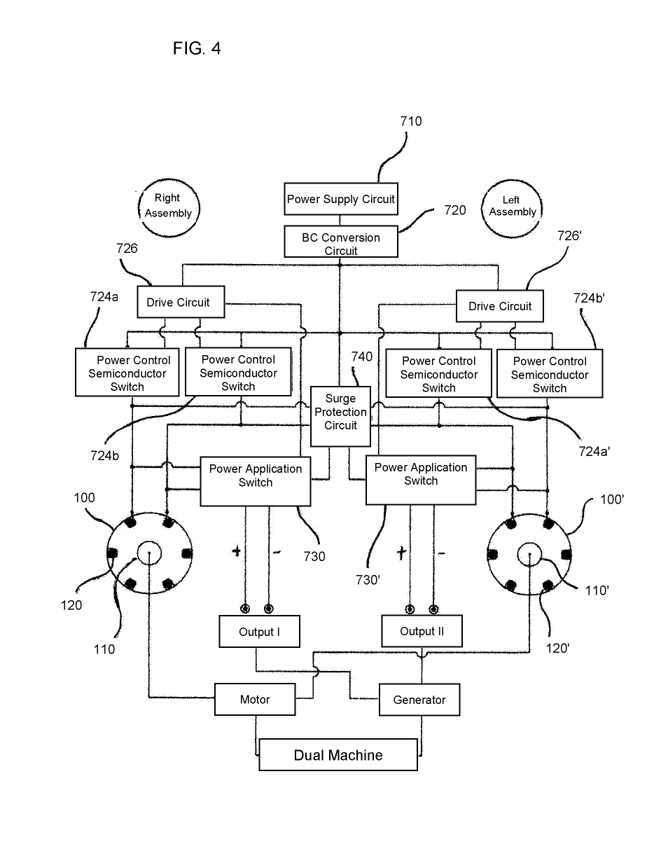

A description of the right assembly 100′ of the dual machine according to the present invention is made in brief. In the case where repulsive current motion and attractive current motion occur in the magnetic current motion system of the left assembly 100, the repulsive current motion becomes the magnetic current of repulsive current that separates the rotor and the stator from each other, based on repulsive current between N and N poles, and the attractive current motion becomes the magnetic current of attractive current that separates the rotor and the stator from each other, based on attractive current between S and N poles. The repulsive current of the stator and the attractive current of the stator activate the stator, and the repulsive current of the rotor and the attractive current of the rotor activate the rotor, so that converted activation current is generated. Meanwhile, magnetic vector motion becomes the action and reaction vectors of repulsive vector motion that separates the rotor and the stator from each other, based on repulsive vectors between N and N poles, and attractive vector motion becomes action and reaction vectors of attractive vector motion that separates the rotor and the stator from each other, based on attractive vectors between S and N poles. The action vector of the stator and the reaction vector of the stator form a sum vector, and the action vector of the rotor and the reaction vector of the rotor form another sum vector, so that conversion torque is generated. Accordingly, magnetic current and magnetic energy are output by semiconductor switching circuits for the converted activation and conversion torque of FIG. 4, which are described later.

A description of the left assembly 100 of the dual machine according to the present invention is made in brief. In the case where repulsive current motion and attractive current motion occur in the magnetic current motion system of the right assembly 100′, the repulsive current motion becomes the magnetic current of repulsive current that separates the rotor and the stator from each other, based on repulsive current between N and N poles, and the attractive current motion becomes the magnetic current of attractive current that separates the rotor and the stator from each other, based on attractive current between S and N poles. The repulsive current of the stator and the attractive current of the stator activate the stator, and the repulsive current of the rotor and the attractive current of the rotor activate the rotor, so that converted activation current is generated. Meanwhile, magnetic vector motion becomes the action and reaction vectors of repulsive vector motion that separates the rotor and the stator from each other, based on repulsive vectors between N and N poles, and attractive vector motion becomes action and reaction vectors of attractive vector motion that separates the rotor and the stator from each other, based on attractive vectors between S and N poles. The action vector of the stator and the reaction vector of the stator form a sum vector, and the action vector of the rotor and the reaction vector of the rotor form another sum vector, so that conversion torque is generated. Accordingly, magnetic current and magnetic energy are output by semiconductor switching circuits for the converted activation and conversion torque of FIG. 4, which are described later.

In the dual machine according to the present invention, the natural spontaneous magnetic motion generated between the rotor and stator of the dual machine implies that the magnetic vector motion and the magnetic current motion occur simultaneously.

In the natural spontaneous magnetic motion, the magnetic vector motion is generated as natural repulsive vector motion is paired with subnatural attractive vector motion, existing along with the repulsive vector motion, and they interact.

Furthermore, in the natural spontaneous magnetic motion, the magnetic current motion is generated as the natural attractive current motion is paired with subnatural repulsive current motion, existing along with the natural attractive current motion.

In the natural spontaneous magnetic motion, the natural repulsive vector motion becomes a first sum vector composed of a group of first action vector and first reaction vector, and the subnatural attractive current becomes a second sum vector composed of a group of second action vector and second reaction vector. As a result, the first sum vector and the second sum vector are added to each other and are subsequently converted into torque force.

Accordingly, the natural spontaneous motion enables rotational motion.

Meanwhile, in the magnetic current motion that is dually performed with the magnetic vector motion, the natural attractive current motion and subnatural repulsive current motion, harmonized with the natural attractive current motion, exist together.

The attractive current motion is composed of a group of first stator attractive current and second rotor attractive current, and the subnatural repulsive current motion is composed of a group of third stator repulsive current and forth rotor repulsive current.

Further, the first stator attractive current of the attractive current motion and the fourth rotor repulsive current of the repulsive current motion are combined with each other and, thus, combination type stator activation current is generated. The second rotor attractive current of the attractive current motion and the fourth rotor repulsive current of the repulsive current motion stator are combined with each other and, thus, combination type stator activation is generated.

The combination type activation current is converted into amplified activation current into which the stator activation current and the rotor activation current are combined and amplified. Accordingly, induced activation electricity is generated and converted into electromotive force.

Accordingly, from the dual machine of FIG. 5, it can be seen that the magnetic vector motion and the magnetic current motion are harmonized and lubricated with respect to each other so as to reduce friction, which is described in detail below. The magnetic motion is achieved using electromagnets and permanent magnets that allow the magnetic vector motion and the magnetic current motion to act smoothly. The magnetic vector motion and the magnetic current motion occur simultaneously. The magnetic motion has visibility such that the magnetic vector motion may be visible by the naked eye, and also has invisibility such that the magnetic current motion may be invisible by the naked eye.

FIG. 4 is a block diagram showing the construction of an electronic control device for controlling the dual machine according to the present invention. In the dual machine of FIG. 4, the generator and the motor, which is formed by the right and left assemblies 100′ and 100, forms a pair, which is described below.

The dual machine 200 of FIG. 4 includes a Direct Current (DC) conversion circuit 720 configured to use Alternating Current (AC) power 100/220, which is provided from a power supply circuit 710, as input power, and rectify the input power by smoothing it, one or more power control semiconductor switches 724a, 724b, 724a′ and 724b′ for converting DC output provided from the DC conversion circuit 720, drive circuit 726 and 726′ respectively connected in series to the power control semiconductor switches 724a, 724b, 724a′ and 724b′ to supply necessary current to the wound coils of the stator of the dual machine, power application semiconductor switches 730 and 730′ respectively connected between drive circuit 726 and 726′ and the power control semiconductor switches 724a, 724b, and 724a′ and 724b′ to switch power input to the drive circuit 726 and 726′, left and right assemblies 100 and 100′ connected to the drive circuit 726 and 726, respectively, and a surge protection circuit 740 for limiting current output through the left and right assemblies 100 and 100′ and preventing damage to the dual machine.

The DC conversion circuit 720 is a constant voltage circuit that is formed of various components, including constant voltage diodes or transistors and capacitors, to form a complete DC waveform through a smoothing circuit.

It is preferred that Insulated Gate Bipolar Transistor (IGBT) devices be adopted for the power control semiconductor switches 724a, 724b, and 724a′ and 724b′. The power control semiconductor switches 724a, 724b, and 724a′ and 724b′ are switches for rapidly switching DC power based on turn-on and turn-off times, and enable rapid switching using on-off states, in which the flow of current through inverters, which switch DC voltage smoothed by the DC conversion circuit 720 into pulses and generate AC voltage, is interrupted, and a stable state.

Each of the power application semiconductor switches 730 and 730′ is a bidirectional triode thyristor for controlling the on-off state of AC power using a triode, can be turned on with respect to any positive and negative direction of power using a plus or minus gate signal, and can perform AC control at a commercial frequency.

In the case where square wave voltage is input and output to/from the wound coils of the fixed assemblies 100 and 100′, the surge protection circuit 740 protects counter electromotive force, which is generated from the wound coils of the fixed assemblies 100 and 100′ of the dual machine, from the surge of a power line and, therefore, prevents the power application semiconductor switches 730 and 730′ and the power control semiconductor switches 724a, 724b, and 724a′ and 724b′ from being damaged.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A dual machine, comprising:
a left assembly comprising a plurality of first magnets, a left stator comprising a plurality of left stator poles; and
a left rotor comprising a plurality of left rotor poles, wherein the left stator poles and the left rotor poles performing attractive motion and repulsive motion in harmony with each other, wherein the plurality of left stator poles comprises a plurality of coils wound around the stator poles;
a right assembly having a plurality of second magnets facing the first magnets, a right stator comprising a plurality of right stator poles, and a right rotor comprising a plurality of right rotor poles, wherein the right stator poles and the right rotor poles performing attractive motion and repulsive motion in harmony with each other, wherein the plurality of right stator poles comprises a plurality of coils wound around the stator poles;
a rotational axis engaging the left rotor to the right rotor rotatably with a predetermined angle between the left and right rotor poles such that the left and right rotor poles are aligned with corresponding left and right stator poles alternatingly during rotation, wherein the left and right stator poles are disposed in same azimuthal direction around the rotational axis;
a plurality of spacers for coupling the left and right stator poles permanently; and
a drive circuit for supplying square wave voltage to the coils around the left and right stator poles alternatingly, wherein the left and right assemblies use both magnetic current and magnetic force, and operate while alternately varying polarity under control of an electronic control device, when the left and right assemblies simultaneously operate while performing a single completed stroke motion, magnetic vector motion generated by the plurality of first magnets is converted into rotational torque at the plurality of second magnets by interaction and harmony between magnetic vector motion and magnetic current motion generated by magnet parts of the left and right assemblies, and allows the dual machine to function as a motor, magnetic current motion generated by the plurality of first magnets allows the dual machine to function as a generator due to harmony between attractive current and repulsive current at the plurality of second magnets, and electromotive force and torque force are output based on a dual function of the motor and the generator, and wherein when the left assembly is driven as a motor the right assembly works as a generator and when the left assembly is driven as a motor the right assembly works as a generator, such that electricity is obtained continuously from the pair of coils wound around the plurality of left and right stator poles.

2. The dual machine as set forth in claim 1, wherein the first magnets comprises the left stator poles and the left rotor poles, wherein the left stator poles and the associated coils form a plurality of electro-magnets and the left rotor poles form a plurality of permanent magnets.

3. The dual machine as set forth in claim 1, wherein the second magnets comprises the right stator poles and the right rotor poles, wherein the right stator poles and the associated coils form a plurality of electro-magnets and the right rotor poles form a plurality of permanent magnets.

4. The dual machine as set forth in claim 1, wherein the left rotor comprises a plurality of rotational arms, wherein the plurality of left rotor poles are disposed on end portions of the rotational arms.

5. The dual machine as set forth in claim 1, wherein the right rotor comprises a plurality of rotational arms, wherein the plurality of right rotor poles are disposed on end portions of the rotational arms.

6. The dual machine as set forth in claim 1, wherein the drive circuit comprises a plurality of power application semiconductor switches for supplying necessary current to the coils of the stators and switching for rapid switching DC power based on turn-on and turn-off times.
